(19) United States
(12) Patent Application Publication
(10) Pub. No.: US 2009/0083811 A1
(43) Pub. Date: Mar. 26, 2009

(54) Unicast Delivery of Multimedia Content

(75) Inventors: James A. Dolce, Hopkinton, MA (US); Rubin Gruber, Concord, MA (US); Michael G. Hluchyj, Wellesley, MA (US); Santosh Krishnan, Wellesley, MA (US); Christopher Lawler, Wellesley, MA (US); Ganesh Pai, Lexington, MA (US); Uma Reddy, Marlborough, MA (US); Stephen Van Seters, Windham, NH (US)

Correspondence Address: PROSKAUER ROSE LLP, ONE INTERNATIONAL PLACE, BOSTON, MA, 02110, US

(73) Assignee: VeriVue, Inc., Westford, MA (US)

(21) Appl. No.: 11/862,049

(22) Filed: Sep. 26, 2007

(51) Int. Cl. H04N 7/173

(52) U.S. Cl. 725/93

(57) ABSTRACT

Described herein are techniques, including methods and systems, including computer program products, for unicast delivery of multimedia content. A broadcast program and a video-on-demand program are ingested by a video delivery module. At least a portion of the broadcast program and at least a portion of the video-on-demand program are stored. The broadcast program, the video-on-demand program, or both are delivered as a unicast video stream to a first single subscriber through a multiplexer connected to a plurality of subscribers.

### FIELD OF THE INVENTION

The present invention relates generally to computer-based methods and apparatuses, including computer program products, for unicast delivery of multimedia content.

The following is a list of some of the acronyms used in this document:

### AES—Advanced Encryption Standard

### ATSC—Advanced Television Systems Committee.

### CBR—Constant Bit Rate

CMTS—Cable Modem Termination System

### DH—Distribution Hub

### DOS—Denial-of-service

### DOCSIS—Data Over Cable Service Interface Specification

### DPI—Digital Program Insertion

### DSL—Digital Subscriber Line

### DSLAM—Digital Subscriber Line Access Multiplexer

### DVD—Digital Video Disc

### DVR—Digital Video Recorder

### EQAM—EdgeQAM

### ES—Elementary Streams

### FEC—Forward Error Correction

### FTP—File Transfer Protocol

### GPON—Gigabit Passive Optical Network

### GOPs—Group-of-Pictures

### HD—High Definition

### HFC—Hybrid Fiber-Coaxial

### HSI—High-Speed Internet

### HTTP—Hyper Text Transfer Protocol

### IGMP—Internet Group Management Protocol

### IPTV—Internet Protocol Television

### ITU—International Telecommunication Union

### LACP—Link Aggregation Control Protocol

### LAG—Link Aggregate Group

### MAC—Media Access Control

### MHE—Master Headend

### MPEG—Moving Picture Experts Group

### MPTS—Multiple Program Transport Stream

nPVR—Network-Based PVR

### OLT—Optical Line Termination

### ONT—Optical Network Termination

### PAT—Program Association Table

### PC—Personal Computer

### PCR—Program Clock Reference

### PES—Packetized Elementary Streams

### PHY—Physical Interface

### PON—Passive Optical Network

### PTS—Presentation Timestamp

### PVR—Personal Video Recorder

### QAM—Quadrature Amplitude Modulation

### RAI—Random Access Indicator

### RG—Residential Gateway

### RTCP—Real-Time Control Protocol

### RTP—Real-Time Transport Protocol

### SCTE—Society of Cable Telecommunications Engineers

### SDV—Switched Digital Video

### SPTS—Single Program Transport Stream

### STB—Set Top Box

### TCP—Transmission Control Protocol

### TS—Transport Stream

### VBR—Variable Bit Rate

### VOD—Video on Demand

### VHO—Video Hub Office

VSO—Video serving Office

### BACKGROUND

The dominant form of home video consumption today is through television delivered by off-the-air broadcast, cable television, satellite television and telecom fiber and Digital Subscriber Line (DSL) services. Home-based video entertainment also reaches the television through Digital Video Disc (DVD) purchases and rentals and through personal computers (PCs), game consoles and specialized television set top boxes (STBs) that download video content (typically over broadband data networks attached to the Internet) for later viewing.

Technology for transporting video is transitioning from analog standards such as NTSC and PAL to digital standards such as ATSC using standard video coding algorithms such as ITU Recommendations H.262 (MPEG-2) and H.264 (MPEG-4 Advanced Video Coding). In some examples of telecom deployments of Internet Protocol Television (IPTV), the broadcast model of content distribution is fundamentally preserved using multicast technology. Here a video broadcast is divided into IP packets by an encoder or other processing element. The stream of IP packets corresponding to a video/audio/data program flow is replicated at intermediate network routers and switches on downstream links based on requests originated by the STB through Internet Group Management Protocol (IGMP) messages. Channel changes by subscribers result in STB-originated IGMP messages requesting “leaves” and “joins” to IP multicast addresses. Like in broadcast, all subscribers requesting a given channel are watching the same program stream. Multicast protocols ensure that program streams are only replicated on downstream links for which the channel has been requested by a downstream STB. Both broadcast and multicast are highly efficient in the use of network resources, as one transmission is shared by many subscribers. However, this efficiency comes at the expense of content flexibility and choice for the subscriber.

Moreover, technologies for home-based storing of video content is transitioning from analog technologies such as Video Cassette Recorders (VCRs) using Video Home System (VHS) tapes to digital technologies incorporating computer hard disks in either purpose-built recording devices or integrated recording devices in a service provider supplied STB. Like their analog VCR counterparts, these so called Personal Video Recorder (PVR) or Digital Video Recorder (DVR) devices allow consumers to time-shift a program by recording it at the time of broadcast for later viewing. The subscriber operates the PVR through a remote control which, in combination with a display screen on the television, allows the subscriber to search and select programs to record based on time, program title, series, genre and lead actors, among other attributes. Depending on the capabilities of the DVR, one or more programs can be recorded simultaneously while watching previously recorded content.

Solutions also exist for storing video content in the service provider network using video on demand (VOD) systems. Here a subscriber, using a remote control with his STB can browse and in some systems search for content such as movies and television programs stored on the VOD system. This stored content can be viewed using remote control commands like play, pause, rewind and fast forward in a similar manner as used in controlling a DVD or PVR device. The video is typically stored at a headend or hub location on some combination of arrayed hard disks and solid-state memory (e.g., DRAM) using custom-built or off-the-shelf servers.

While VOD systems typically involve prerecorded movies, the application of VOD systems have also been expanded beyond movies to selected television programs and television broadcast programs, allowing network-based PVR (nPVR) (i.e., PVR/DVR services that are stored on the network instead of at the subscriber's location). With nPVR, the subscriber is offered a home-based PVR experience except that the video content is stored in VOD servers in the network. This allows a lower cost deployment option for the service provider as VOD stored content is shared among multiple users (stored once but viewed by many) and lower cost, non-hard drive enabled STBs can be deployed in subscriber homes.

### SUMMARY OF THE INVENTION

One approach to delivery of multimedia content is a unicast delivery of multimedia content. In one aspect, there is system for unicast delivery of multimedia content. The system includes a buffer. The buffer is configured to ingest a broadcast program and a video-on-demand program. The buffer is further configured to store at least a portion of the broadcast program and at least a portion of the video-on-demand program. The buffer is further configured to deliver the broadcast program, the video-on-demand program, or both as a unicast video stream to a first single subscriber through a multiplexer connected to a plurality of subscribers.

In another aspect, there is a system for unicast delivery of multimedia content. The system includes a means for ingesting a broadcast program and a video-on-demand program. The system further includes a means for storing at least a portion of the broadcast program and at least a portion of the video-on-demand program. The system further includes a means for delivering the broadcast program, the video-on-demand program, or both as a unicast video stream to a first single subscriber through a multiplexer connected to a plurality of subscribers.

In another aspect, there is a method for unicast delivery of multimedia content. The method includes ingesting a broadcast program and a video-on-demand program. The method further includes storing at least a portion of the broadcast program and at least a portion of the video-on-demand program. The method further includes delivering the broadcast program, the video-on-demand program, or both as a unicast video stream to a first single subscriber through a multiplexer connected to a plurality of subscribers.

In another aspect, there is a computer program product for unicast delivery of multimedia content. The computer program product is tangibly embodied in an information carrier. The computer program product includes instructions being operable to cause a data processing apparatus to ingest a broadcast program and a video-on-demand program. At least a portion of the broadcast program and at least a portion of the video-on-demand program are stored. The broadcast program, the video-on-demand program, or both are delivered as a unicast video stream to a first single subscriber through a multiplexer connected to a plurality of subscribers.

Another approach to multimedia content is a video delivery module. In one aspect, the video delivery module includes a network interface controller module, a media module, a storage module, and a switch fabric. The network interface controller module is connected to a network interface port and configured to receive a broadcast program and a video-on-demand program from a network and transmit the broadcast program, the video-on-demand program, or both to a subscriber. The media module is configured to process the broadcast program, the video-on-demand program, or both for storage and process the broadcast program, the video-on-demand program, or both for delivery to the subscriber. The storage module is configured to store the broadcast program, the video-on-demand program, or both. The switch fabric is configured to connect the network interface controller module to the media module, connect the media module to the storage module, connect the storage module to the media module, and/or connect the media module to the network interface controller module.

In another aspect, the video delivery module includes a means, connected to a network interface port, for receiving a broadcast program and a video-on-demand program from a network and transmitting the broadcast program, the video-on-demand program, or both to a subscriber. The video delivery module further includes a means for processing the broadcast program, the video-on-demand program, or both for storage and processing the broadcast program, the video-on-demand program, or both for delivery to the subscriber. The video delivery module further includes a means for storing the broadcast program, the video-on-demand program, or both. The video delivery module further includes a means for connecting the network interface controller module to the media module, connecting the media module to the storage module, connecting the storage module to the media module, and/or connecting the media module to the network interface controller module.

In another aspect, the video delivery module includes a network interface controller module, a media module, a data switch fabric, a storage module, and a media switch fabric. The network interface controller module is connected to a network interface port and is configured to receive a video program from a network and transmit the video program to a subscriber. The media module is configured to process the video program for storage and process the video program for delivery to the subscriber. The data switch fabric is configured to connect the network interface controller module to the media module. The storage module is configured to store the video program. The media switch fabric is configured to connect the media module to the storage module.

In another aspect, there is a method of processing a program in a video delivery switch. The method includes receiving, at a network interface controller module connected to a network interface port, a broadcast program and a video-on-demand program from a network. The method further includes connecting, by a switch fabric, the network interface controller module to a media module. The method further includes processing, by the media module, the broadcast program, the video-on-demand program, or both for storage. The method further includes connecting, by the switch fabric, the media module to a storage module. The method further includes storing, by the storage module, the broadcast program, the video-on-demand program, or both. The method further includes connecting, by the switch fabric, the storage module to the media module. The method further includes processing, by the media module, the broadcast program, the video-on-demand program, or both for delivery to a subscriber. The method further includes connecting, by the switch fabric, the media module to the network interface controller module. The method further includes transmitting, by the network interface controller module, the broadcast program, the video-on-demand program, or both to the subscriber.

In another aspect, there is a computer program product. The computer program product is tangibly embodied in an information carrier. The computer program product includes instructions being operable to cause a data processing apparatus to receive, at a network interface controller module connected to a network interface port, a broadcast program and a video-on-demand program from a network. Connect, by the network interface controller module, a switch fabric to a media module. Process, by the media module, the broadcast program, the video-on-demand program, or both for storage. Connect, by the switch fabric, the media module to a storage module. Store, by the storage module, the broadcast program, the video-on-demand program, or both. Connect, by the switch fabric, the storage module to the media module. Process, by the media module, the broadcast program, the video-on-demand program, or both for delivery to a subscriber. Connect, by the switch fabric, the media module to the network interface controller module. Transmit, by the network interface controller module, the broadcast program, the video-on-demand program, or both to the subscriber.

In other examples, any of the approaches and/or aspects above can include one or more of the following features. The buffer is further configured to store a plurality of advertisement programs. The buffer is further configured to determine a first advertisement selected from the plurality of advertisement programs based on information associated with the first single subscriber and to insert the first advertisement program into the unicast video stream for delivery to the first single subscriber.

In some examples, the buffer is further configured to determine a second advertisement selected from the plurality of advertisement programs based on information associated with a second single subscriber, which is one of the plurality of subscribers and different than the first single subscriber and to insert the second advertisement program into a second unicast video stream for delivery to the second single subscriber.

In other examples, the buffer is further configured to insert an advertisement program from the plurality of advertisement programs into the broadcast program, the video-on-demand program, or both during the ingest. The buffer is further configured to deliver the broadcast program, the video-on-demand program, or both with the inserted advertisement program to a group of the plurality of subscribers.

In some examples, the buffer is further configured to store a portion of the broadcast program separately from the full portion of the broadcast program. The buffer is further configured to transmit the portion of the broadcast program to the first single subscriber based on a request for a broadcast program.

In other examples, the request for a broadcast program comprises a channel change request in a multi-channel network. The multiplexer comprises a DSLAM, an OLT, and/or an EQAM modulator. The unicast video stream is delivered through a subscriber line, which includes a copper line, a fiber optic line, and/or a cable television line. The buffer includes non-volatile storage, volatile storage, or both.

In some examples, the unicast video stream includes a real time program for transmission to the single subscriber. The unicast video stream includes a non-real time program for transmission to the single subscriber.

In other examples, a plurality of advertisement programs are stored. A first advertisement selected from the plurality of advertisement programs is determined based on information associated with the first single subscriber, which is one of the plurality of subscribers and the first advertisement program is inserted into the unicast video stream for delivery to the first single subscriber.

In some examples, determining a second advertisement selected from the plurality of advertisement programs is determined based on information associated with a second single subscriber, which is different than the first single subscriber and one of the plurality of subscribers and the second advertisement program is inserted into a second unicast video stream for delivery to the second single subscriber.

In other examples, an advertisement program from the plurality of advertisement programs is inserted into the broadcast program, the video-on-demand program, or both during the ingesting. The broadcast program, the video-on-demand program, or both are delivered with the inserted advertisement program to a group of the plurality of subscribers. A portion of the broadcast program is stored separately from the full portion of the broadcast program.

In some examples, the portion of the broadcast program to the single subscriber is transmitted based on a request for a broadcast program. The request for a broadcast program includes a channel change request in a multi-channel network.

In other examples, the storage module includes a media storage controller module, a broadcast circular buffer module, or both. The media storage controller module is further configured to store a plurality of advertisement programs. The media module includes an ingest media module, a delivery media module, or both.

In some examples, the ingest media module is further configured to insert an advertisement program, which is selected from the plurality of advertisement programs based on information associated with a plurality of subscribers, during processing of the broadcast program, the video-on-demand program, or both for storage.

In other examples, the delivery media module is further configured to insert an advertisement program, which is selected from the plurality of advertisement programs based on information associated with the subscriber, during processing of the broadcast program, the video-on-demand program, or both for the subscriber.

In some examples, the ingest media module is further configured to index the broadcast program, the video-on-demand program, or both. The ingest media module is further configured to determine a location in the indexed program to begin the transmission of the indexed program. The broadcast circular buffer module further configured to store a portion of the broadcast program based on the index of the broadcast program.

In other examples, the broadcast circular buffer module is further configured to store a portion of the broadcast program. The switch fabric directly connects two modules to transfer the broadcast program, the video-on-demand program, or both between the two modules. The switch fabric includes a data switch fabric, a media switch fabric, or both.

In some examples, the data switch fabric further is configured to connect the network interface controller module to a media module, to connect the media module to the network interface controller module, or both. The media switch fabric is further configured to connect the media module to a storage module, to connect the storage module to the media module, or both.

In other examples, the network interface controller module is further configured to classify data based on information associated with the data and determine whether to accept the data based on the classification of the data. The network interface controller module is further configured to schedule the transmission of the broadcast program, the video-on-demand program, or both to the subscriber based on information associated with the network.

In some examples, a plurality of advertisement programs are stored by the storage module. An advertisement program, which is selected from the plurality of advertisement programs based on information associated with a plurality of subscribers, is inserted by the media module, during the processing of the broadcast program, the video-on-demand program, or both for storage.

In other examples, an advertisement program, which is selected from the plurality of advertisement programs based on information associated with the subscriber, is inserted by the media module, during processing of the broadcast program, the video-on-demand program, or both for delivery to the subscriber.

In some examples, the broadcast program is indexed by the media module and a portion of the broadcast program is stored by the storage module based on the index of the broadcast program. The portion of the broadcast program is transmitted, by the network interface controller module, based on a channel change request from the subscriber.

An advantage is that the dedicated IP bandwidth from the telecom video serving office or cable headend to each served home is sufficient for each served television and/or multimedia device in each home to receive an individualized content stream, which allows the subscriber to watch what he or she wants, when he or she wants to watch the content. Another advantage is that the overall cost of providing an individualized content stream to each home can be reduced by the utilization of the different types of storage modules for broadcast television and for video on demand. Another advantage is that both broadcast and video on demand individualized content can be delivered to the requesting subscriber in real time without disrupting the streaming of content to other subscribers. Another advantage is that a unicast stream can be provided by adding a video delivery module into the existing delivery network without a major overhaul of that existing network. The techniques described herein may include one or more of the advantages noted above.

Other approaches, aspects, examples, and/or advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 depicts an exemplary cable television system including media storage and routing modules;

FIG. 2 depicts an exemplary cable distribution network including a media storage and routing module;

FIG. 3 depicts an exemplary telecom internet protocol television (IPTV) system including a media storage and routing module;

FIG. 4 depicts an exemplary telecom IPTV network including a media storage and routing module;

FIG. 5A depicts an exemplary media storage and routing module configured in server mode;

FIG. 5B depicts an exemplary media storage and routing module configured in bypass mode;

FIG. 5C depicts an exemplary media storage and routing module configured in in-line switching mode;

FIG. 6 depicts an exemplary video delivery module;

FIG. 7 depicts an exemplary data flow through a video delivery module;

FIG. 8 depicts an exemplary network interface controller module;

FIG. 9 depicts an exemplary ingest media module;

FIG. 10 depicts an exemplary delivery media module;

FIG. 11 depicts an exemplary broadcast circular buffer module; and

FIG. 12 depicts an exemplary media storage controller module.

### DETAILED DESCRIPTION

The techniques described herein enable the application of VOD systems expanding beyond movies and selected television programs to the real-time ingest of television broadcast programs to allow network-based PVR (nPVR) and time-shifted television. Network-based time shifting allows the subscriber to view recently broadcast programs within a window of a few hours. Unlike a PVR or nPVR service of the prior art however, with some of the techniques described herein, the subscriber does not have to pre-select a future program for recording. Instead, the subscriber is allowed to look backwards in time and start from the beginning of a program that has already aired or has already begun to air. Subject to content owner restrictions, the broadcast program is stored in real-time to be made available to subscribers for unicast viewing at a future time, typically within a few hours of its original broadcast, but perhaps as long as several days or a week.

In addition to delivering stored content to subscribers, by enabling a unicast delivery of multimedia content, the techniques herein increase the number of available broadcast channels to subscribers. Worldwide, there are over 22,000 television broadcast stations. Given the global economy and migration of families and workers, the techniques advantageously provide broadcast channel bundles to subscriber affinity groups. In this way, a subscriber from another country or even from another region within a country can view channels from their home country or region.

Also having an impact on television services is the evolution of the Internet. The Internet has evolved from a network that allowed simple messaging, file transfer and remote access to a full multimedia experience with search, search-based advertising, gaming, and media streaming. Users are able to search for content, view content, including streaming media, from any broadband connected device (e.g., personal computer) located anywhere in the world. This searchable, on-demand access to content has led to an explosion in Internet use and the successful application of search-based and other relevancy-based targeted advertising. This has in turn led the television and advertising industries to consider how a more targeted and interactive advertising model can be used in television. Interactive advertising is emerging in the cable industry with Enhanced TV initiatives at CableLabs. Targeted advertising exist today in the form of local spot advertisements spliced into a broadcast program directed to a limited geography (e.g., a metro region or even zip code) using standards such as Society of Cable Telecommunications Engineers (SCTE) 30 and SCTE 35. Using the techniques herein, the simultaneous targeting or addressing of specific advertisements, among a large set of advertisements, to each individual subscriber is accomplished. An advantage is that individualized advertisements can be delivered to subscribers without regard to the geography of the subscriber.

In other examples, the techniques herein enable a flexible, efficient, and cost effective system for a subscriber to rapidly select from among thousands of live broadcast channels, view stored content such as movies, television programs, and/or documentaries. The stored video content can be that which is transferred from a video library to a VOD server and that which has been recorded from off-air broadcast for time-shifting and nPVR applications. In the latter case, the delay from live broadcast to time-shifting lasts as little as a few seconds. Moreover, to achieve the benefits of targeted advertising, individually addressed advertisements to subscribers are allowed for stored and live television viewing experiences. These addressable ads can incorporate interactivity to allow for telescoping to long-form infomercials and on-screen purchasing. An advantage is that subscribers can watch what they want (live or stored), when they want, supported by advertisements specific to their interests and needs.

In some examples, the system for cable broadcast and/or telecom IPTV multicast services is designed to carry individualized video streams to every subscriber to accommodate long-tail broadcast, time-shifted television, and/or targeted advertising. By way of example, a High Definition (HD) MPEG-2 video stream can consume as much as 19 Mb/s. A telco video serving office (VSO) or cable DH providing service to 10,000 homes, each home with three HD television sets, would need to deliver an aggregate of 570 Gb/s to the subscribers served by the VSO/DH in order for each STB to receive a personalized video stream, commonly referred to as a unicast service. As this unicast content typically originates from a telco Video Hub Office (VHO) or cable Master Headend (MHE) serving 20 or more VSOs or DHs, respectively, the aggregate VHO/MHE bandwidth is about 11 Tb/s if the VHO/MHE provides all of the unicast streams. As described in more detail below, the architectures and techniques enable individualized unicast delivery of content to subscribers without such high aggregated bandwidth requirements at the VHO/MME or the VSO/DH.

In other examples, the broadcast and VOD services, while sharing cable RF spectrum or telco metro and access networks, are provided as separate services using distinct service enabling equipment and the system can utilize cable and/or telco networks. In examples in the prior art, cable systems deploying SDV and VOD services share RF spectrum and Quadrature Amplitude Modulation (QAM) resources, but are served using separate elements. While such a separation of the services into different elements makes for a highly distributed solution, the techniques described herein can provide, for example, resource allocation and service which is responsive as subscribers switch among services in a manner similar to switching among broadcast channels.

Moreover, as more video services are delivered to subscriber televisions through IP networks, service providers must consider the security implications of the network which become more venerable to denial-of-service (DOS) attacks and other Internet inspired service disruptions. Also, the nature of IP networks for delivering TV services requires video delivery elements to be more network aware, incorporating Layer 2 switching and possibly Layer 3 routing functions to allow for improved interconnection through application of advanced network protocols like Ethernet IEEE 802.3ad to provide Link Aggregate Group (LAG) methods of interconnection. Such protocols improve the reliability and simplicity of interconnecting video delivery elements with IP metro and access networks. The techniques described herein take into account such IP issues so that an IP-based media stream can be transported from the originating point all the way to the subscriber.

To provide a context for the techniques that will be described in detail, the following example describes a high level overview of the flow and use of the programs that are delivered. In general overview, a subscriber requests a television program to watch on his or her television set. A media storage and routing module at a subscribing node receives the request and determines if the request can be fulfilled from its storage modules. If the request can be fulfilled from the media storage and routing module's storage modules, then the requested program is streamed through a multiplexer (e.g., DSLAM, OLT, EQAM) over the subscriber lines to the subscriber's television set. If the request cannot be fulfilled from the media storage and routing module's storage modules, then the requested program is received from a regional node or a national node, stored in the storage modules, and streamed through the multiplexer over the subscriber lines to the subscriber's television set. The storage modules temporarily store broadcast television programs (e.g., real time television programs) in volatile storage for channel changing, ad insertion, and/or any other type of time delay use of the programs. The storage modules store the broadcast television programs and/or video on demand programs (e.g., non-real time television programs) in non-volatile storage for future streaming to subscribers.

For example, George Smith requests “Days around the World” which is currently broadcasting on channel 774. The media storage and routing module is receiving channel 774 and storing “Days around the World” in non-volatile storage for future video on demand to subscribers (subject to any legal and/or regulatory restrictions). The media storage and routing module is also buffering “Days around the World” in volatile memory so that thirty seconds of the program is in memory and ready to be streamed to a requesting subscriber (in this example, as a fast channel change). Since Mr. Smith requested the real-time broadcast of the television program, the media storage and routing module streams the television program from the volatile memory to a multiplexer to perform the channel change. The multiplexer streams the television program through the subscriber line (e.g., fiber optic cable) to Mr. Smith's television set for viewing. The media storage and routing module continues to stream the broadcast program through the multiplexer to Mr. Smith's television set for viewing until he requests another channel change. Advantageously, the media storage and routing module can insert advertisement programs that are selected specifically for Mr. Smith into the broadcast program,

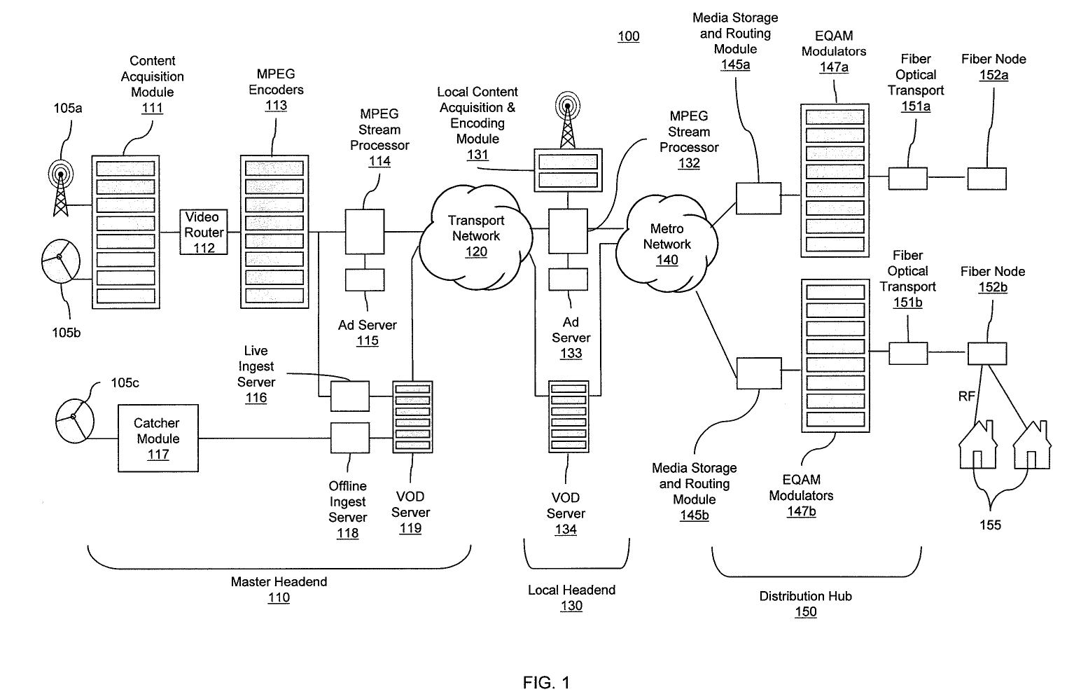

FIG. 1 depicts an exemplary cable television system 100 including media storage and routing modules 145a and 145b (generally 145). Cable television systems 100 were designed around the original broadcast model of television where the transmission of an RF video signal over coaxial cable is available to all the .homes (155) connected to the cable system. With cable, the available RF spectrum on an 850 MHz cable plant allows for the broadcast of hundreds of digital channels to STBs in subscriber homes 155. As described in more detail herein, the media storage and routing modules 145 can provide these broadcast channels to subscribers on an individualized basis, for example, time shifting or inserting customized content (e.g., targeted advertising). An advantage is that this is a very efficient distribution of content and supports a unicast model where subscribers can view whatever video content they wish, whenever they desire.

In the exemplary cable television system 100, the master headend 110 receives content and processes the content for transport over a transport network 120. In the master headend 110, the content is received via the antenna 105a and/or satellite receivers 105b and 105c. For real-time content, the content is acquired by a content acquisition module 111 as the content is received by the antenna 105a and satellite 105b. The content is routed from the content acquisition module 111 to MPEG (movie picture experts group) encoders 113 via a video router 112. The content is encoded to MPEG by the MPEG encoders 113. The content in MPEG is transmitted to a MPEG stream processor 114 and a live ingest server 116. The MPEG stream processor 114 processes the MPEG content to stream the content through the transport network to a local headend 130. An ad server 115 communicates with the MPEG stream processor 114 to insert ads into the content stream. Because the master headend 110 services all subscribers nationally, the ad server 115 inserts advertisement programs that are selected for the entire national viewing audience. The live ingest server 116 processes the content (e.g., creates trick files, creates bookmarks for the content) and transmits the content to a VOD server 119.

For non-real-time content, the content is acquired by a catcher module 117. The catcher module 117 transmits the content to an offline ingest server 118. The offline ingest server 188 processes the content (e.g., creates trick files, creates bookmarks for the content) and transmits the content to the VOD server 119.

The VOD server 119 stores the content for future use and/or streams the content to a local headend 130. The VOD server 119 transmits the stored content to the MPEG stream processor 132 and/or VOD server 134 associated with the local headend 130. In other examples, the VOD server 119 transmits the content directly to the media storage and routing module 145a or 145b. In some examples, the MPEG stream processor 114 transmits the content directly to the media storage and routing module 145a or 145b.

The local content acquisition and encoding module 131 receives local content (e.g., local television station news broadcast). The MPEG stream processor 132 processes the received content from the local acquisition module 131 and inserts ads received from the ad server 133. Because the local headend 130 services subscribers that are local to that particular local headend 130, the ad server 133 inserts advertisement programs that are selected for the particular viewing audience associated with that local headend 130 (e.g., the greater Boston area). The MPEG stream processor 132 transmits content via a metro network 140 to a distribution hub 150 (analogous to a VSO in telco network). The distribution hub 150 includes a media storage and routing module 145a or 145b.

The media storage and routing module 145 stores the content for future subscriber requests and/or stores the content for current subscriber requests. When stored content on the media storage and routing module 145 is requested, the media storage and routing module 145 transmits the content to an EdgeQAM (EQAM) modulator 147a or 147b (generally 147) (in this example, a multiplexer which is connected to a plurality of subscribers). The EQAM modulator 147 processes the content (e.g., modulates the content) for transmission through the transmission lines (e.g., fiber optic lines) via a radio frequency (RF). The content is transmitted through a fiber optic transport 151a or 151b (generally 151) to a fiber node 152a or 152b (generally 152). Each fiber node 152 is connected to one or more subscriber homes 155.

Although FIG. 1 illustrates two media storage and routing modules 145a and 145b, a plurality of media storage and routing modules (e.g., ten, fifty, one hundred) can, for example, communicate with a local headend 130.

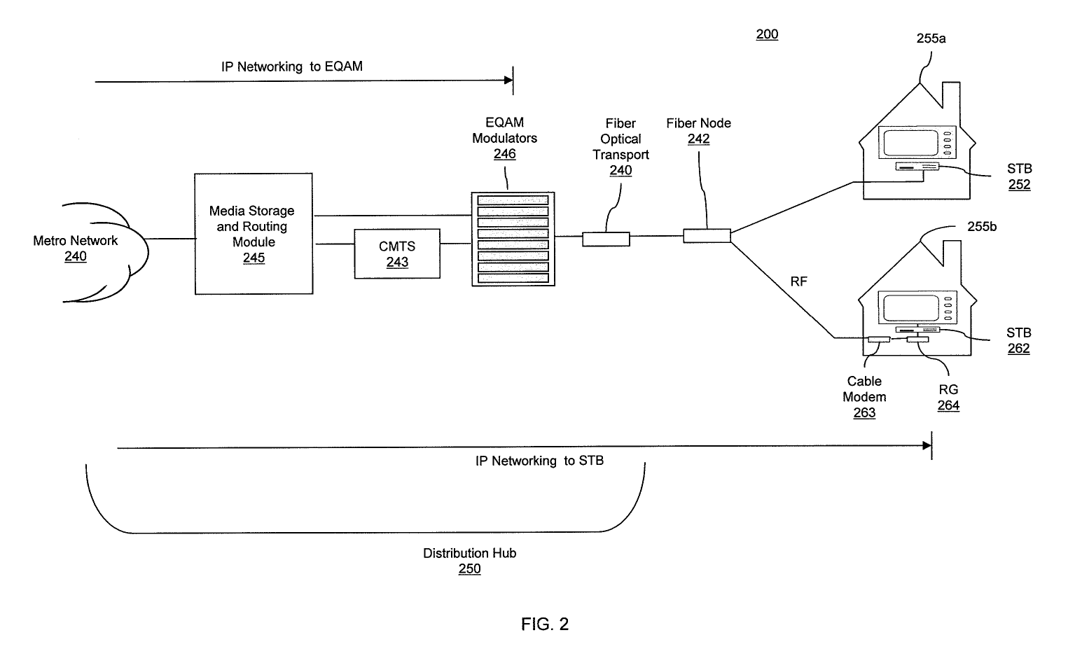

FIG. 2 depicts an exemplary cable distribution network 200 which includes a media storage and routing module 245. The media storage and routing module 245 receives content via a metro network 240. The media storage and routing module 245 stores content and upon a request from a subscriber, routes the requested content to the subscriber's home 255a or 255b (generally 255). The media storage and routing module 245 transmits the requested content directly to an EQAM modulator 246 and/or to a cable modem termination system (CMTS) 243. In a typical scenario, the media stream is IP-based to and through the media storage and routing module 245. Without the use of the CMTS 243, the stream can be converted into a media stream decipherable by a set top box (STB) 252.

The use of the CMTS 243 enables the content to remain IP-based and to be transmitted to the subscriber 255 in an IP format. The EQAM modulator 246 processes the content and transmits the content through a fiber optical transport 240 and a fiber node 242 to the requesting subscriber's home 255. The content that is transmitted from the media storage and routing module 245 to the CMTS 243 is transmitted from the EQAM modulators 246 to a cable modem 263. The cable modem 263 processes the IP packets and transmits the content to a residential gateway (RG) 264. The RG 264 transmits the content to the subscriber's STB 262 and then the content is displayed on the subscriber's television for viewing. This example can enable, for example, IP networking to the STB 262.

For example, a Hybrid Fiber-Coaxial (HFC) infrastructure deployed in cable network 200, with fiber node splits, EdgeQAM (EQAM) deployment and reclamation of analog and digital broadcast spectrum, unicast TV delivery to all served homes is achievable. The downstream QAM capacity of an 850 MHz cable plant is approximately 4.6 Gb/s. With fiber node splits to 125 homes passed and assuming a 60% subscriber acquisition rate, each of the 75 served homes will have available about the same capacity as in a GPON deployment.

Although FIG. 2 illustrates the televisions connected to set top boxes 252 and 262, the subscriber can request and/or view a program utilizing any computing device (e.g., personal computer, mobile phone, and the like).

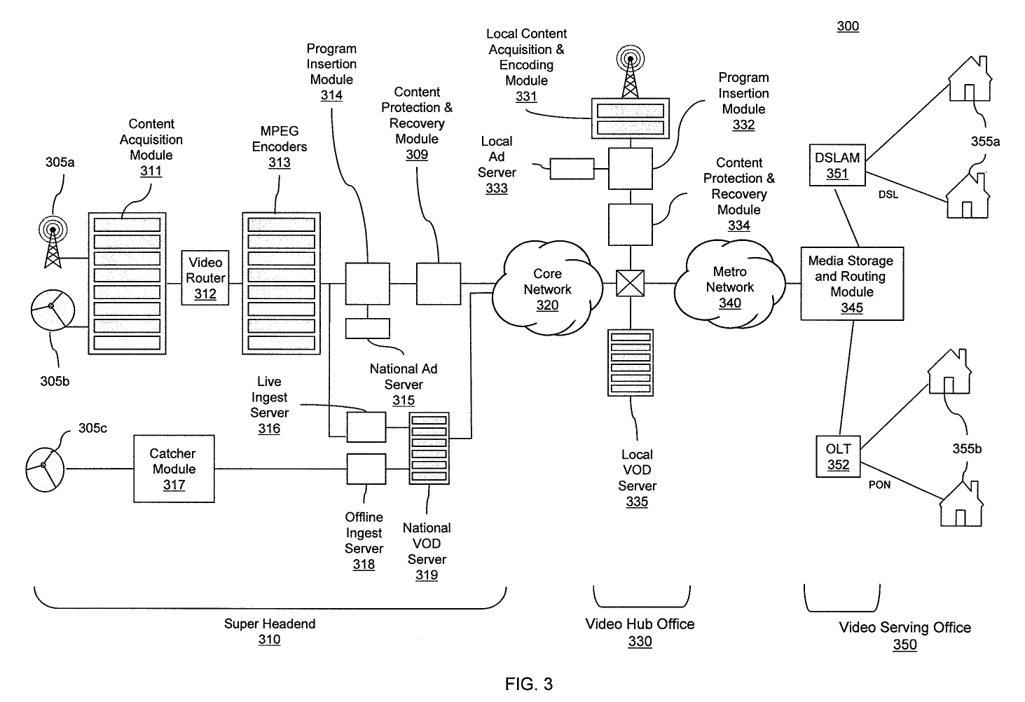

FIG. 3 depicts an exemplary telecom internet protocol television (IPTV) system 300 which includes a media storage and routing module 345. The exemplary telecom television system 300 can provide subscribers with whatever video content they wish, whenever they desire. The super headend 310 receives content and process the content for transport over a core network 320. In the super headend 310, the content is received via the antenna 305a and/or satellite receivers 305b and 305c. For real-time content, the content is acquired by a content acquisition module 311 as the content is received by the antenna 305a and/or satellite 305b. The content is routed from the content acquisition module 311 to MPEG encoders 313 via a video router 312. The content is encoded to MPEG by the MPEG encoders 313. The content in MPEG is transmitted to a program insertion module 314, which inserts ads received from a national ad server 315, and a live ingest server 316. The program insertion module 314 transmits the content with the inserted national ads to a content protection and recover module 309. The content protection and recover module 309 processes the content (e.g., adds copy protection) and transmits the content to the core network 320. The live ingest server 316 processes the content (e.g., creates trick files, creates bookmarks for the content) and transmits the content to a national VOD server 319.

For non-real-time content, the content is acquired by a catcher module 317. The catcher module 317 transmits the content to an offline ingest server 318. The offline ingest server 318 processes the content (e.g., creates trick files, creates bookmarks for the content) and transmits the content to the national VOD server 319.

The national VOD server 319 stores the content for future use and/or streams the content to a video hub office 330. The national VOD server 319 transmits the stored content to the local VOD server 335 associated with the video hub office 330. In other examples, the national VOD server 319 transmits the content directly to the media storage and routing module 345. In some examples, the content protection and recovery module 309 transmits the content directly to the media storage and routing module 345.

The local content acquisition and encoding module 331 receives local content (e.g., local television station news broadcast). The program insertion module 332 processes the local content and inserts ads received from a local ad server 333. The content protection and recover module 334 processes the received content from the video hub office 330 and the program insertion module 332. The content protection and recovery module 334 transmits content via a metro network 340 to a video serving office 350 and/or transmits content to a local VOD server 335 for storage.

The video serving office 350 includes the media storage and routing module 345. The media storage and routing module 345 stores the content for future subscriber requests and/or stores the content for current subscriber requests. When stored content on the media storage and routing module 345 is requested, the media storage and routing module 345 transmits the content to a digital subscriber line access multiplexer (DSLAM) 351 and/or an optical line terminator (OLT) 352 for transmission to the subscriber's home 355a or 355b. In this example, the DSLAM 351 and OLT 352 are each a multiplexer which is connected to a plurality of subscribers. The DSLAM 351 processes the content for transmission over a DSL line to the subscriber's home 355a. The OLT processes the content for transmission over a passive optical network (PON) to the subscriber's home 355b.

Although FIG. 3 illustrates one media storage and routing module 345, a plurality of media storage and routing modules (e.g., ten, fifty, one hundred) can, for example, communicate with the video hub office 330.

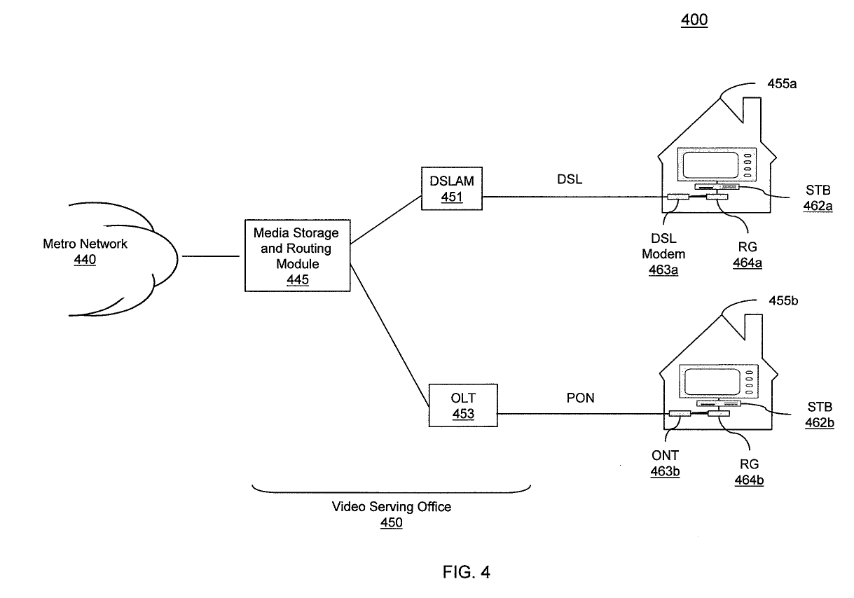

FIG. 4 depicts an exemplary telecom IPTV network 400 which includes a video serving office 450. The video serving office 450 includes a media storage and routing module 445. The media storage and routing modules 445 receives content via a metro network 440 and stores the content. Upon a request from a subscriber, the media storage and routing module 445 routes the request content to the subscriber's home 455a or 455b (generally 455). The media storage and routing module 445 transmits the requested content to a DSLAM 451 or OLT 453 depending on the transmission line of the requesting subscriber's home 455a or 455b, respectively.

For DSL transmission, the content is routed to the DSLAM 451 for processing and transmission over a DSL line. A DSL modem 463a receives the content and processes the content (e.g., converts the content from a DSL compatible format to residential gateway compatible format). The content is transmitted from the DSL modem 463a to a residential gateway (RG) 464a. The RG 464a transmits the content to the subscriber's STB 462a and then the content is displayed on the subscriber's television for viewing.

For PON transmission, the content is routed to the OLT 453 for processing and transmission over a PON line. An optical network termination (ONT) 463b receives the content and processes the content (e.g., converts the content from a PON compatible format to residential gateway compatible format). The content is transmitted from the ONT 463b to a residential gateway (RG) 464b. The RG 464b transmits the content to the subscriber's STB 462b and then the content is displayed on the subscriber's television for viewing.

An advantage of the media storage and routing module is that an access network build-out allows for dedicated IP bandwidth from the telco VSO or cable DH to each served home sufficient for each served television and/or multimedia device in each home to receive an individualized content stream (unicast delivery of multimedia content).

In a telecom deployment, each DSL terminated on DSLAM 451 in the video serving office 450 provides sufficient capacity downstream to each served home and upstream toward the media storage and routing module 445 in the video serving office 450 to accommodate the requirement that each television and/or multimedia device in the home can receive an individualized content stream. Utilizing VDSL2 technology, it is possible to provide subscribers, for example, with 25 Mb/s access over copper loops up to five thousand feet and higher speeds over shorter distances. This affords sufficient capacity from the DSLAM to each home when using MPEG4 AVC video coding for at least two HD and one SD televisions in each served home.

In telecom PON deployments (e.g., BPON, GPON, EPON, GEPON), fiber is deployed from the OLT 453, typically located in the video serving office 450, to one or more homes 455a and 455b over an optical distribution network utilizing passive optical components. Fiber PON technology can provide, for example, even greater subscriber capacity than DSL with, for example, GPON providing 2.4 Gb/s shared among thirty two to sixty four homes.

While there is sufficient capacity in the “last mile” of next generation access networks, the delivery of the individualized unicast streams from the core and metro networks, where the aggregate bandwidth to a VHO or MHE is measured in several Tb/s, is challenging, if not impossible. The media storage and routing module 445 advantageously is located to take advantage of that last mile capacity, so that, by being located at the edge of the metro network 440, there are no capacity issues with the media storage and routing module 445 providing unicast streams to each of the subscribers 455.

In some examples, the individualized unicast stream utilizes a telecom network (see FIGS. 3 and 4) and/or a cable network (see FIGS. 1 and 2). The telecom network and/or the cable network can deliver, for example, video via IP networking all the way to the home (using cable standards such as DOCSIS) and when IP is terminated on the EQAM for video delivery.

In some examples, to solve the bandwidth expense of delivering multiple unicast video streams to each home from the core and metro networks, the media storage and routing module (e.g., 145 in FIG. 1, 245 in FIG. 2, 345 in FIG. 3 445 in FIG. 4) is deployed in the subscriber serving office (e.g., distribution hub 150 of FIG. 1, distribution hub 250 of FIG. 2, video serving office 350 of FIG. 3, video serving office 450 of FIG. 3). In other examples, the media storage and routing module utilizes a plurality of ten Gigabit Ethernet (10GE) ports and/or any other network interface utilizing different technology and with higher and lower capacities. In other examples, some of the ports are dedicated to ingesting video content (via streaming and downloads) from the core and metro networks (i.e., ingest ports) and the remaining ports are dedicated to delivering content toward the subscribers (i.e., delivery ports).

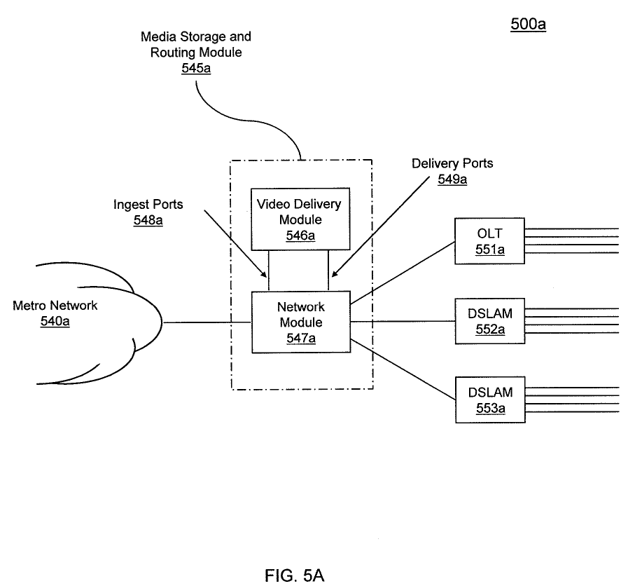

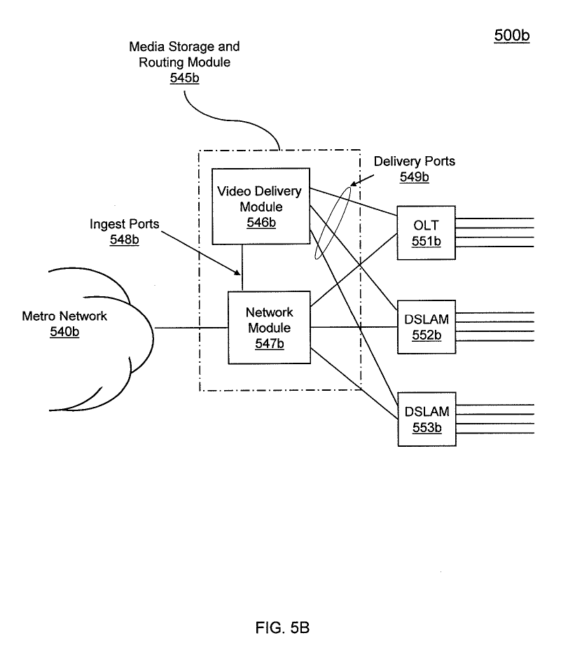

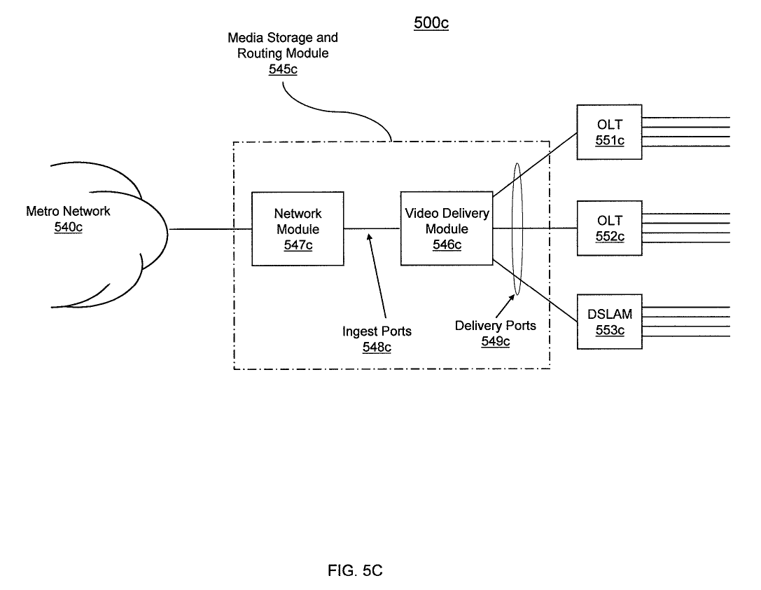

FIGS. 5A, 5B, and 5C depict exemplary configurations of the media storage and routing module, where a video delivery module, described in more detail below, can be located in parallel or in series with the network module (e.g., a router). FIG. 5A depicts an exemplary media storage and routing module 545a configured in server mode in a network 500a. The media storage and routing module 545a includes a video delivery module 546a, a network module 547a (e.g., a router), ingest ports 548a, and delivery ports 549a. The ingest ports 548a and the delivery ports 549a provide for communication between the video delivery module 546a and the network module 547a. Content is received by the network module 547a from a metro network 540a. The network module 547a routes the content through the ingest ports 548a (e.g., through one of the plurality of ingest ports 548a) to the video delivery module 546a. The video delivery module 546a processes and stores the content. Upon a subscriber's request, the video delivery module 546a transmits the requested content through the delivery ports 549a (e.g., through one of the plurality of delivery ports 549a) to the network module 547a. The network module 547a transmits the requested content to a subscriber's home (not shown) through the OLT 551a or DSLAM 552a or 553a in the transmission pathway to the subscriber's home.

FIG. 5B depicts an exemplary media storage and routing module 545b configured in bypass mode in a network 500b. The media storage and routing module 545b includes a video delivery module 546b, a network module 547b, ingest ports 548b, and delivery ports 549b. The ingest ports 548b provide for communication between the video delivery module 546b and the network module 547b. The delivery ports 549b provide for communication between the video delivery module 546b and an OLT 551b or DSLAM 552b or 553b in the transmission pathway to a subscriber's home (not shown). Content is received by the network module 547b from a metro network 540b. The network module 547b routes the content through the ingest ports 548b (e.g., through one of the plurality of ingest ports 548b) to the video delivery module 546b. The video delivery module 546b processes and stores the content. Upon a subscriber's request, the video delivery module 546b transmits the requested content through the delivery ports 549b (e.g., through one of the plurality of delivery ports 549b) to the subscriber's home through the OLT 551b or DSLAM 552b or 553b in the transmission pathway to the subscriber's home. An advantage of the video bypass mode of operation for the media storage and routing module 545b is that the number of ports are reduced and the capacity on the network module 547b is reduced which decreases the overall cost of the media storage and routing module 545b.

In some examples, the network module 547b communicates signaling information with the subscriber's homes through the OLT 551b and/or the DSLAM 552b or 553b. In other examples, requested content is streamed directly from the metro network 540b to the network module 547b to the subscriber's home which bypasses the video delivery module 546b.

FIG. 5C depicts an exemplary media storage and routing module 545c configured in in-line switching mode in a network 500c. The media storage and routing module 545c includes a video delivery module 546c, a network module 547c, ingest ports 548c, and delivery ports 549c. The ingest ports 548c provide for communication between the video delivery module 546c and the network module 547c. The delivery ports 549c provide for communication between the video delivery module 546c and the subscriber's home through an OLT 551c or 552c or DSLAM 553c. Content is received by the network module 547c from a metro network 540c. The network module 547c routes the content through the ingest ports 548c (e.g., through one of the plurality of ingest ports 548c) to the video delivery module 546c. The video delivery module 546c processes and stores the content. Upon a subscriber's request, the video delivery module 546c transmits the requested content through the delivery ports 549c (e.g., through one of the plurality of delivery ports 549a) to the subscriber's home (not shown) through the OLT 551c or DSLAM 552c or 553c in the transmission pathway to the subscriber's home. An advantage of the in-line switching mode of operation for the media storage and routing module 545c is that the number of ports are reduced and the capacity on the network module 547c is reduced which decreases the overall cost of the media storage and routing module 545c.

In some examples of the in-line switching mode, the media storage and routing module 545c supports delivery of non-video IP traffic (e.g., data and voice). In other examples (not shown), a single port of the video delivery module 546 may be bidirectional and shared to ingest video content in one direction, and deliver content towards the subscriber in another.

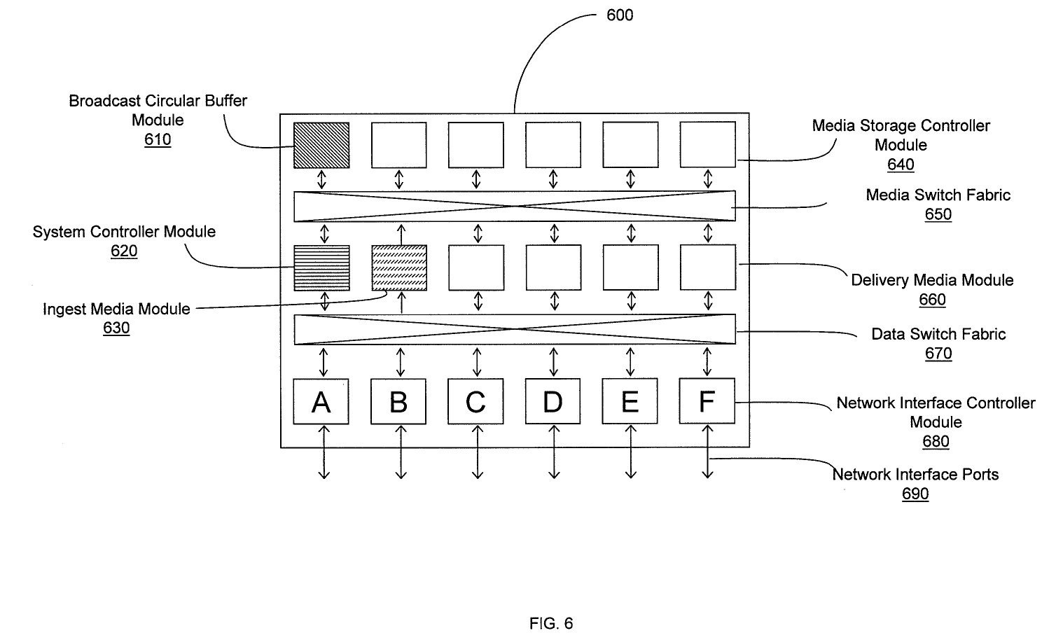

FIG. 6 depicts an exemplary video delivery module 600. The video delivery module 600 includes a broadcast circular buffer module 610, a system controller module 620, an ingest media module 630, a media storage controller module 640, a media switch fabric 650, a delivery media module 660, a data switch fabric 670, a network interface controller module 680, and network interface ports 690. The network interface ports 690 include ingest and delivery ports which are attached to network interface controller modules 680 (e.g., network interface cards). Each network interface controller module 680 can provide Layer 2 packet processing functions for each of the terminated network interface ports 690. The network interface ports 690 are coupled to the data switch fabric 670 that can provide a Layer 2 switching function among the network interface controller modules 680 and the delivery media modules 660, the system controller module 620, and the ingest media module 630.

The ingest media module 630 and the delivery media module 660 are coupled to both the data switch fabric 670 and the media switch fabric 650. The data switch fabric 670 allows packets arriving on any network interface port to be switched to the appropriate media module (e.g., delivery media module 660, ingest media module 630) and/or system controller module 620 and/or allows a packet generated by any media module and/or system controller module 620 to be delivered to any network interface port 690. For example, a delivery media module 660 may be assigned to deliver a video stream to a specified STB based on the availability of processing and streaming resources of each of the delivery media modules 660.

In the bypass configuration of FIG. 5B, access to the STB is only possible via a subset of network interface ports 690. For example, those network interface ports 690 attached to the specific DSLAM 552b or 553b or OLT 551b are the only ports that can serve the STB. In this example, the data switch fabric 670 provides the packet connectivity for the video stream to transit from the delivery media module 660 to the appropriate network interface controller module 680 through which the network interface ports 690 are attached. Likewise on ingest, the arriving video streams or video file downloads are switched via the data switch fabric 670 to the appropriate ingest media module 630 that is assigned to process the incoming video packets.

The media modules 630 and 660 are coupled to the broadcast circular buffer module 610 and media storage controller modules 640 via the media switch fabric 650. In some examples, the media switch fabric can be equivalent to the data switch fabric 670. In other examples, the media switch fabric is optimized to transport media streams from the ingest media module 630 to a plurality of media storage controller modules 640 in a synchronized and/or coordinated fashion, such as striped across a plurality of media storage controller modules 640. The media switch fabric 650 can also perform the reverse in retrieving media from the plurality of media storage controller modules 640 and transporting the stream (e.g., plurality of packets) to the delivery media module 660 for transmission to a subscriber.

The broadcast circular buffer module 610 is used to store the recent history of each of the incoming broadcast channels received by the video delivery module 600 via one or more network interface controller modules 680 and the ingest media module 630 assigned to perform the ingest media processing. In other words, the broadcast circular buffer 610 stores some portion smaller than the full broadcast program. For example, the broadcast circular buffer module 610 can store the equivalent in video frames of two or more Group-of-Pictures (GOPs) of the Moving Picture Experts Group (MPEG) stream (typically 1-20 seconds) and is used to facilitate fast channel change among the ingested broadcast channels. The media storage controller module 640 is used for longer term storage (hours or even days or weeks or months) of ingested video (broadcast streams or files) used to provide VOD and time-shifting services of broadcast programs. The media storage controller module 640 can also be, for example, used to store ad video files to be used in spot and targeted advertisements for broadcast, VOD, and/or time-shifted services, for advertisements that are customized for a target group smaller than the local node, such as certain neighborhoods, or even individual subscribers, via their unicast stream.

In some examples, the modules of the video delivery module 600 described above are software modules operating on a server and/or a group of servers (e.g., server farm). In other examples, the modules as described above are each individual computing blades (e.g., computing card with processor, memory, and input/output devices) in a blade server. The computing blades in the blade server can be, for example, interconnected with a switch fabric. In some examples, the modules as described above are each individuals servers interconnected with each other in a network.

In other examples, the switch fabrics 650 and 670 are network modules that allow for connections between any of the devices connected to the switch fabrics 650 and 670. The switch fabrics 650 and 670 provide high speed transmission of data between a plurality of modules connected to the switch fabrics 650 and 670. For example, network interface controller F can connect to the system controller module 620 during one time period and during the next time period, network interface controller F can connected to the ingest media module 630. The switch fabrics 650 and 670 can provide, for example, a direct connection between the connected modules.

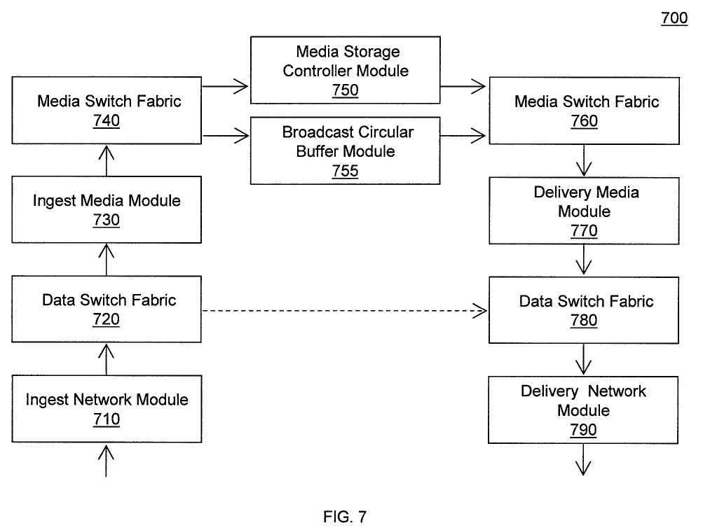

FIG. 7 depicts an exemplary data flow through the video delivery module 600 of FIG. 6. An ingest network module 710 (can also be an ingest network interface controller module) receives a packetized video stream. The video stream is communicated from the ingest network module 710 to a data switch fabric 720 which establishes a connection between the ingest network module 710 and an ingest media module 730. The ingest media module 730 processes the video stream. The media switch fabric 740 establishes a connection between the ingest media module and the media storage controller module 750 and broadcast circular buffer module 755. The media storage controller module 750 stores the video stream and the broadcast circular buffer module 755 temporarily stores the current portion of video stream for broadcast.

Upon a user's request for content, the delivery media module 770 obtains the requested content from the media storage controller module 750 and/or the broadcast circular buffer module 755 through the media switch fabric module 760. The delivery media module 770 connects to the delivery network module 790 (can also be a delivery network interface controller module) through the data switch fabric module 780. The content is delivered to the subscriber's television or other viewing device through a transmission network (e.g., a fiber optic network).

In some examples, the content bypasses the media switch fabric 740 and 760 and is communicated from the ingest network module 710 through the data switch fabric 720 and 780 to the delivery network module 790. An advantage is that programs that do not require processing or storage can be directly streamed to the requesting subscriber which improves the efficiency of the streaming and decreases the transmission time of the program.

For real-time video streaming, packets may arrive through a multicast join of the video delivery module 600 to a known multicast address carrying the specified video stream. In some examples, the underlying network protocol is IP with user datagram protocol (UDP) and/or real-time transport protocol (RTP) used for carrying the MPEG transport stream (TS) packets using standard methods. In other examples, transmission control protocol (TCP) can be used for transferring the video in a file transfer and/or progressive download mode of operation.

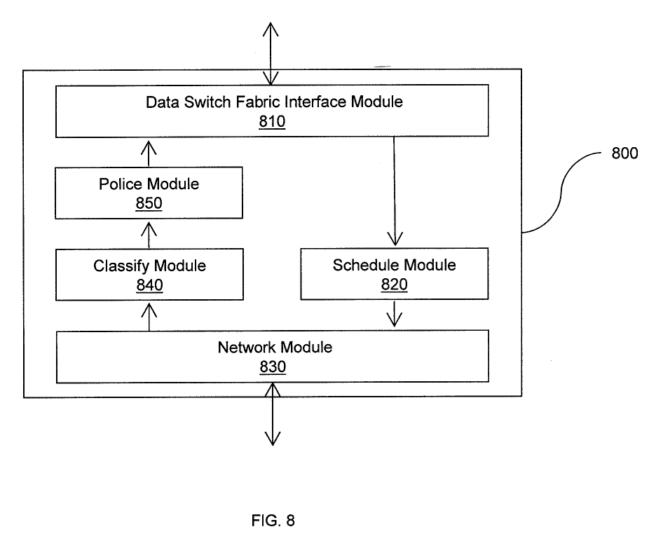

FIG. 8 depicts an exemplary network interface controller module 800. The network interface controller module 800 includes a data switch fabric interface module 810, a schedule module 820, a network module 830, a classify module 840, and a police module 850. Packets are received by the data switch fabric interface module 810 and/or the network module 830. Packets received by the data switch fabric interface module 810 are packets transmitted from the data switch fabric 670 of FIG. 6. These packets are communicated to the schedule module 820 which schedules the transmission of the packet. These packets are communicated to the network module 830 which transmits the packets through a network interface port 690 to a subscriber's home.

Packets received by the network module 830 are received from the network interface ports 690. These packets are transmitted from the network module 830 to the classify module 840. The classify module 840 classifies the packet based on packet source/destination address, protocol identifiers, port numbers, and/or other information contained within the network protocol headers. As part of the packet classification function, an internal routing header is attached to each packet and used by the data switch fabric 670 to route the packet to the appropriate ingest media module 630.

An arriving packet not matching a known classification can be, for example, discarded by the classify module 840. This provides the first level of security protection in the video delivery module 600. Packets classified and not discarded are next sent to the police module 850 where the packet arrival rate on known media and signaling flows is monitored for excessive rates. Excessive signaling rates might be caused by faulty networking elements (e.g., a faulty STB sending excessive signaling messages to the video delivery module) and/or coordinated denial of service (DOS) attacks intended to disrupt service. The police module 850 discards excessive packets to provide a second level of protection to the video delivery module 600 media and control processing functions. The packets not discarded by the police module 850 are sent to the data switch fabric interface module 810 which in turn connects to the data switch fabric 670 for transit to the appropriate ingest media module 630.

In some examples, the network interface controller module 800 supports IEEE 802.3 compliant Ethernet port interfaces and includes the physical interface (PHY) and Media Access Control (MAC) packet processing In other examples, the network interface controller module 800 supports IEEE 802.3ad LAG. Here individual 802.3 Ethernet interfaces can be grouped into IEEE 802.3ad aggregated links to form a single logical trunk port to a single destination device. IEEE 802.3ad Link Aggregation Control Protocol (LACP) provides for simpler configuration and growth of Ethernet trunks between the video delivery switch 600 and external switching, routing and OLT/DSLAM equipment as illustrated in FIGS. 5A, 5B, and 5C. IEEE 802.3ad LACP facilitates interface port redundancy for achieving highly available solutions. For example, if one network interface port or cable were to fail, packets that would normally be sent on that interface can be automatically moved to other interfaces in the LAG using IEEE 802.3ad LACP. It is important that these packets are ultimately delivered to the appropriate media module (e.g., ingest media module 630, delivery media module 660) for processing. The data switch fabric 670 is used to route packets arriving on any network interface port 690 to the appropriate ingest media module 630 or delivery media module 660 assigned to further process the packets.

The data switch fabric 670 moves the packets from an ingest network interface controller module 680 to the assigned ingest media module 630. Data switch fabrics (e.g., 670) are well known in the industry and there are commercially available data switch fabric components with which to build data switch fabrics. For the in-line switching mode of FIG. 5C, the data switch fabric 670 allows ingest network interface controller module 680 to delivery network interface controller module 680 switching of pass-through data traffic.

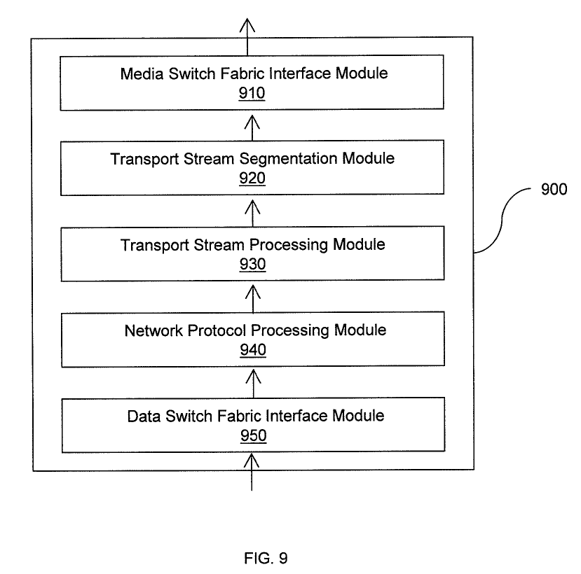

FIG. 9 depicts an exemplary ingest media module 900. The ingest media module 900 includes a data switch fabric interface module 950, a network protocol processing module 940, a transport steam processing module 930, a transport stream segmentation module 920, and a media switch fabric interface module 910. The ingest media module 900 receives packets from the data switch fabric 670 of FIG. 6 on the data switch fabric interface module 950. The data switch fabric interface module 950 forwards the packets to a network protocol processing module 940 which is responsible for upper layer network protocol processing.

RTP is an Internet protocol that supports the transport of real-time media such as video and audio streams across IP networks. RTP is used in combination with Real-Time Control Protocol (RTCP), which monitors delay, jitter, and RTP packet loss. In the case of packet loss, the network protocol processing module 940 of the ingest media module 900 can request a retransmission of lost packets. In other examples, the network protocol processing module 940 can make use of standard techniques of Forward Error Correction (FEC) such as specified in Pro-MPEG Code of Practice 3 to correct for missing RTP packets.

The network protocol processing module 940 is responsible for TCP processing. TCP is a connection-oriented protocol that guarantees reliable and in-order delivery of data from sender to receiver. It is used to reliably transport media content to the video delivery module 600 and is used in conjunction with File Transfer Protocol (FTP) and/or Hyper Text Transfer Protocol (HTTP). The files can be either completely downloaded to the video delivery module 600 before delivery by a delivery media module 660 and/or progressively downloaded wherein the media file can begin to be delivered by a delivery media module 660 before completely received by the ingest media module 900.

In other examples, other transport protocol combinations are supported by the network protocol processing module 940 including TCP transport of RTP packets containing MPEG TS packets, and/or MPEG TS packets carried directly over UDP without the benefit or added overhead of RTP. In all cases, the network protocol processing module 940 performs the necessary protocol processing, including stripping away network protocol headers and/or delivering MPEG TS packets to the transport stream processing function of the ingest media module 900.

The content is transmitted from the network protocol processing module 940 to the transport stream processing module 930. MPEG content may arrive to the video delivery module 600 and ultimately to the transport stream processing module 930 in multiple formats. For example, single program transport stream (SPTS) contains TS packets corresponding to a single program while multiple program transport stream (MPTS) contains TS packets corresponding to multiple programs. The transport stream processing module 930 uses the TS packet headers to separate the individual programs within a MPTS for processing. The TS is further characterized by its data rate profile: constant bit rate (CBR) corresponds to a non-varying data rate for the TS whereas variable bit rate (VBR) corresponds to a variable bit rate for the TS, where generally the rate is capped to a maximum value. The CBR and VBR characterizations can be in reference to MPTS or SPTS. Further, for MPTS, the individual programs may be VBR within a CBR MPTS.

In some examples, a program within a SPTS or each program within an MPTS has associated video, audio and data streams in the form of packetized elementary streams (PES) carried within the TS packets. The PES for video contains the encoded video frames using MPEG-2, MPEG-4, and/or other video coding algorithms. The encoded frames are identified as intra-coded (I), predictive-coded (P) and bi-directionally predictive coded (B) and from a GOP starting with an I-frame followed by a plurality of P and B frames. I-frames contain the complete encoded image of a frame and depend on no other frames, whereas P and B frames essentially represent differences in the image from frame-to-frame starting with the I-frame at the beginning of each GOP. Separate PESs are used to carry the audio streams associated with a program and still other PESs are used for data such as for the Program Association Table (PAT), which contains a list of all programs in the TS. The underlying media streams are referred to as Elementary Streams (ES).

In other examples, the TS and PES packets contain headers with information important not only for decoding at a STB, but also for intermediate processing in the video delivery module 600. The program clock reference (PCR) is sent periodically in the TS header and is used for clock recovery. The presentation timestamp (PTS) is contained in the PES header and is used to determine when a frame is to be displayed relative to the PCR. Random access indicator (RAI) in TS headers are used to determine the start of I-frames. The I-frame location is important for fast channel change since the display of a new channel should start with an I-frame. Locating and storing the most recent I-frame, along with the subsequent P and B frames in the GOP starting with that I-frame, allows the system to always start the transmission of a new channel on an I-frame boundary and therefore reduce the time from when a channel is changed until the new channel content is displayed on a television.

Returning to FIG. 9, the transport stream processing module 930 is responsible for MPTS demultiplexing into the component PES for each program carried within the MPTS. For SPTS, only a single program is contained within the TS, but still the component PES must be extracted for later processing. Based on information in the TS and PES headers, the program streams are parsed and indexed by the transport stream processing module 930 for use in fast channel change, trick mode operations (e.g., fast forward and rewind), and/or ad splicing. Fast channel change requires the location of I-frames as discussed previously. Trick mode operation requires the location of I-frames corresponding to certain PTS values. For ad splicing, cue messages, as defined in SCTE35, identify the location where ads may be inserted into the content and need to be indexed for use in later splicing operations.

In some examples, the index of the program is utilized to determine a location in the indexed program for transmission. The location of the indexed program can be, for example, utilized to transmit the indexed program starting at the specified location in the program.

In other examples, local ads that are targeted to a zone within or encompassing an entire video serving office are inserted by the transport stream processing module 930 in the ingest media module 900. The local ads can be, for example, determined based on information associated with the selected group of subscribers (e.g., demographics, geographic, cable provider, television viewing statistics). Individually targeted ads can be, for example, inserted by the delivery media module 660 as described later. In some examples, digital program insertion (DPI) for ad splicing may require the transrating of content to provide seamless splicing of the ad into the program. With a seamless splice, the decoder buffer in the STB neither underflows nor overflows and each and every one of the frames of the ad are displayed on the television.

In other examples, for content protection, an arriving ES may be encrypted using, for example, advanced encryption standard (AES). Other headers, like the PES headers, can be, for example, encrypted. To transrate the content for the purposes of seamless ad splicing it is necessary to decrypt the ES and any encrypted headers and then re-encrypt the content after the DPI function.

In some examples, the transport stream processing module 930 of the ingest media module 900 includes the capabilities to decrypt and re-encrypt protected content and perform DPI using transrating methods for seamless ad splicing.

The transport stream segmentation module 920 of the ingest media module 630 segments the TS content for efficient storage in either or both the broadcast circular buffer module 610 and/or media storage controller module 640. Included here are the indexing information used to efficiently access specific TS packets for use in fast channel change, and for trick mode and DPI operations on the stored programs. The fast channel change can be, for example, based on a request from a subscriber for a channel change (e.g., from channel fifty to channel ten). The channel change requests can be, for example, associated with multi-channel networks (e.g., television network with two hundred channels).

The segmented TS packet stream is sent to the media switch fabric interface module 910 which in turn is coupled to the media switch fabric 650. The media switch fabric 650 is responsible for transferring segmented TS content to the appropriate storage modules. The media switch fabric 650 can be realized, for example, using a variety of different methods, including using those used in the realization of the data switch fabric 670, to move the segmented TS content to the appropriate storage modules (e.g., media storage controller module 640). In some examples, a data switch fabric 670 could serve both functions of interconnecting network interface controller modules 680 with media modules (e.g., delivery media modules 660 and ingest media module 630) and interconnecting media modules with broadcast circular buffer modules 610 and media storage controller modules 640.

In some examples, each program stream is delivered by the media switch fabric 650 to either or both the broadcast circular buffer module 610 and one or more media storage controller module 640. The broadcast circular buffer module 610 stores in volatile storage (e.g., DRAM) the last N seconds of content for each received broadcast channel, where N is configurable but typically the equivalent of one or two GOPs. The media storage controller modules 640 store in non-volatile storage (e.g., disk or flash) content stored for longer periods to support VOD and other time-shifted television services. Individual program streams can be stored on a single media storage controller module 640 or striped across multiple media storage controller modules 640 in a RAID-like fashion. The latter option provides better protection of content from media storage controller module 640 failures and offers greater concurrency of access to a single program title by multiple users.

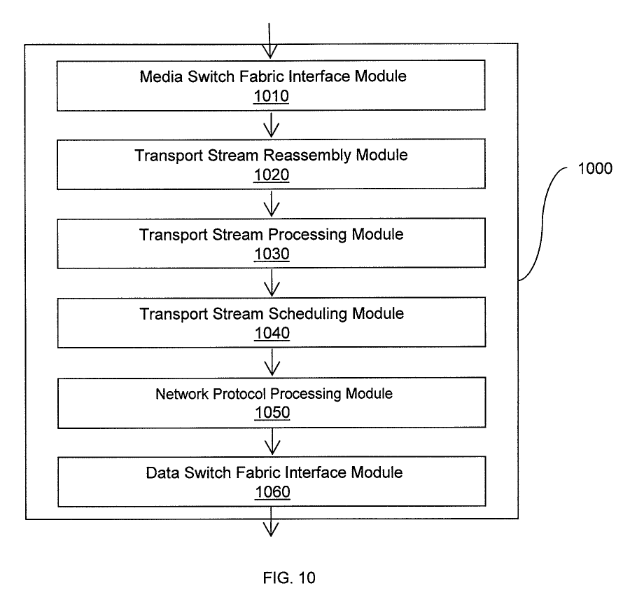

FIG. 10 depicts an exemplary delivery media module 1000. The delivery media module 1000 receives the segmented TS content from the media switch fabric 650 of FIG. 6 via the media switch fabric interface module 1010. The TS is then reassembled by the transport stream reassembly module 1020 and passed to the transport stream processing module 1030 for additional TS processing before scheduled for delivery by the transport stream scheduling module 1040. The transport stream processing module 1030 includes DPI for splicing individually targeted ads to each subscriber served by the delivery media module 660. The individually targeted ads can be, for example, determined based on information associated with the individual subscriber (e.g., viewing statistics, demographic, purchase information). Because the delivery media module 1000 can prepare a unicast stream for a particular subscriber, or even a stream for a particular device, the media module 1000 can insert an advertisement program into a broadcast program or a VOD program that is customized for that particular subscriber on that particular device.

In some examples, decryption and encryption of the content may be necessary along with transrating and restamping of PCR and PTS values in the TS and PES headers, respectfully, and are supported by the transport stream processing function. When required for cable distribution in the “IP networking to EQAM” mode of delivery (see FIG. 2), the transport stream processing function converts the separate program streams into an MPTS as required for content delivery to the EQAM. The process of forming the MPTS out of multiple VBR streams requires a statistical multiplexing function to ensure the MPTS data rate fits into the CBR profile required by the EQAM (e.g., 38.8 Mb/s for 256QAM). This statistical multiplexing is performed by the transport stream processing function.

The transport stream scheduling module 1040 determines the transmission time of TS packets. Here the transport stream scheduling module 1040 avoids STB decoder buffer underflow and overflow. The transport stream scheduling module 1040 can, for example, make use of RTP time stamps received on ingested streams and/or PCR values in the TS packet headers to determine the delivery time of TS packets to the network protocol processing function of the delivery media module 1000. The transport stream scheduling function also supports scheduling for trick mode operation where the indexed PTS values are used to determine which TS packets to schedule depending on the specific fast forward and rewind commands relayed via the STB to the video delivery module.

The network protocol processing function of the delivery media module 660 is responsible for upper layer network protocols used to transport the TS packets over the access network infrastructure to the STB. Again, RTP and TCP protocols are accommodated by the network protocol processing function with support for RTP retransmission for error recovery between the video delivery module and STB. The network protocol processing module 1050 for RTP supports, for example, FEC for error correction to accommodate STBs with that mode of packet loss error recovery.

As with the network protocol support on the ingest media module 630, the network protocol processing module 1050 of the delivery media module 1000 supports other network protocol modes including TCP transport of RTP packets containing MPEG TS packets and MPEG TS packets carried directly over UDP, among many other possible combinations.

The RTP and TCP packets generated by the network protocol processing module 1050 of the delivery media module 1000 are relayed to the data switch fabric interface module 1060 for transport over the data switch fabric 670 to the appropriate network interface controller module 680 assigned to deliver the content stream over an attached network interface port 690. The delivery network interface controller module 680 includes a packet schedule module to effectively multiplex the various RTP and TCP packet flows onto each network interface port. As discussed previously, the network interface controller module 680 supports IEEE 802.3ad LAG for simpler configuration and growth of Ethernet trunks between the video delivery module and external switching, routing and OLT/DSLAM and to facilitate interface port redundancy for achieving highly available solutions.

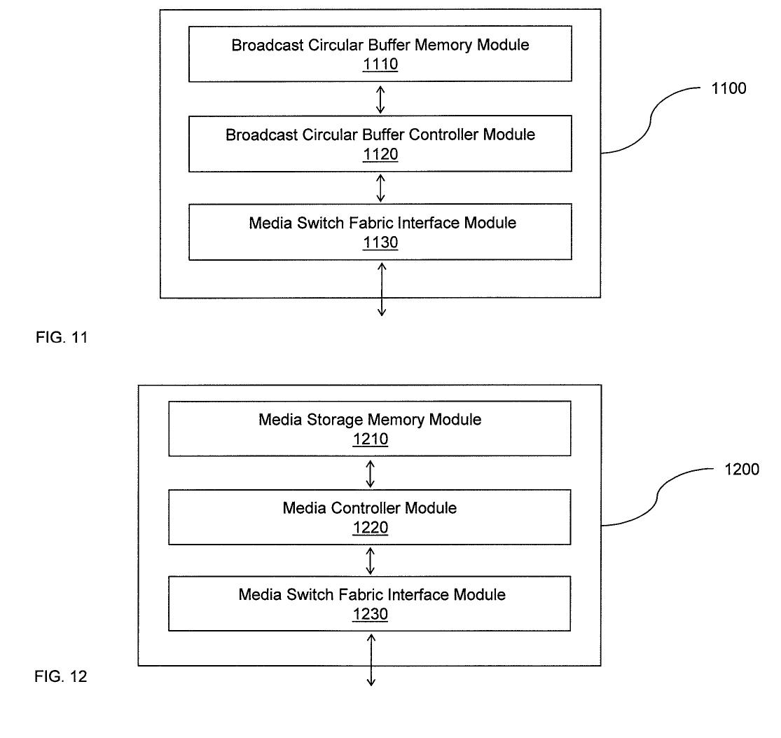

Referring now to FIG. 11, FIG. 11 depicts an exemplary broadcast circular buffer module 1100. The broadcast circular buffer module 1100 includes a media switch fabric interface module 1130 coupled to a broadcast circular buffer controller module 1120 which in turn is coupled to a broadcast circular buffer memory module 1110 where the segmented TS content is stored.

Referring now to FIG. 12, FIG. 12 depicts an exemplary media storage controller module 1200. The media storage controller module 1200 includes a media switch fabric interface module 1230 coupled to a media controller module 1220 which in turn is coupled to a media storage memory module 1210 where the segmented TS content is stored.

In an exemplary overview of operation, the delivery of content to subscribers can begin with a user selection of content via an Electronic Programming Guide (EPG) and/or other user interface (e.g., VOD search) displayed on the television by the attached STB. Alternatively, the user may simply employ the up-down channel change buttons on a remote control to surf for a broadcast channel to view. These user selections result in signaling messages sent to the video delivery module (e.g., 600 of FIG. 6) that is providing the service to the subscriber STB. The video delivery module, through the operation of control plane software operating on one more of the video delivery modules (including on dedicated system controllers 620), determines which delivery media module (e.g., 660) is assigned to stream the selected content to the STB for ultimate display on the television. The assigned delivery media module uses an internal database to determine if the requested content is local to the video delivery module, that is, available from the broadcast circular buffer module (e.g., 610) for broadcast services or stored on one or more media storage controller modules (e.g., 640) for VOD or time-shifted services. If the content is local to the video delivery module, then the delivery media module assigned to deliver the content initiates the reading of the segmented TS content from the broadcast circular buffer module and/or media storage controller module, as appropriate.

For the broadcast circular buffer module 1100 of FIG. 11, the broadcast circular buffer controller module 1120 initiates reads from the broadcast circular buffer memory module 1110 and then uses the media switch fabric interface module 1130 to transfer the segmented TS content to the assigned delivery media module 660 via the media switch fabric 650. For the media storage modules 1200, the media controller module 1220 initiates reads from the media storage memory module 1210 and then uses the media switch fabric interface module 1230 to transfer the segmented TS content to the assigned delivery media module 660 via the media switch fabric 650.

In some examples, if the content requested by a user is not local to the video delivery module, then though a distributed exchange of content location maps or through a centralized content resource management function, the location of the content is determined and a request message is sent from the video delivery module supporting the STB requesting the content to the video delivery module that is determined to have a copy of the content. The overall system can be, for example, configured in a hierarchical fashion. That is, if the video delivery module at the subscriber servicing node (e.g., video serving office, distribution hub) supporting the STB does not have the requested content, then the request is relayed to the regional node (e.g., video hub office, local headend). Likewise, if the regional node supporting the subscriber servicing node does not have the requested content, then the request is further relayed to a video delivery module and/or content library (e.g., video on demand server) at the national node (e.g., super headend, master headend). In all cases, the content is relayed through the video delivery module at the subscriber servicing node as this video delivery module represents a single point of contact for the STB to the video delivery system. This single point of contact facilitates user authentication and application control, core network topology hiding and protection from malicious attackers, and/or content flow monitoring for improved network troubleshooting.

In some examples, the subscriber servicing node is located on an edge of a metropolitan area network and is closer to the multiplexer than the regional node or the national node. In other examples, the subscriber servicing node is directly connected to a multiplexer which is connected to a plurality of subscribers via subscriber lines (e.g., telephone line, fiber optic line, cable television line).

In other examples, with alternate transport stream processing modules in the ingest media module and delivery media module, the video delivery module may support streaming and download of non-MPEG encoded video.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device and/or in a propagated signal, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include and/or can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

A network can include, for example, a packet-based network and/or a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The computing device can include, for example, a television with a set top box, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A system for unicast delivery of multimedia content, the system comprising:
a buffer configured:
to ingest a broadcast program and a video-on-demand program;
to store at least a portion of the broadcast program and at least a portion of the video-on-demand program; and
to deliver the broadcast program, the video-on-demand program, or both as a unicast video stream to a first single subscriber through a multiplexer connected to a plurality of subscribers.

2. The system of claim 1, wherein the buffer is further configured to store a plurality of advertisement programs.

3. The system of claim 2, wherein the buffer is further configured:
to determine a first advertisement selected from the plurality of advertisement programs based on information associated with the first single subscriber; and
to insert the first advertisement program into the unicast video stream for delivery to the first single subscriber.

4. The system of claim 3, wherein the buffer is further configured
to determine a second advertisement selected from the plurality of advertisement programs based on information associated with a second single subscriber, which is one of the plurality of subscribers and different than the first single subscriber; and
to insert the second advertisement program into a second unicast video stream for delivery to the second single subscriber.

5. The system of claim 2, wherein the buffer is further configured to insert an advertisement program from the plurality of advertisement programs into the broadcast program, the video-on-demand program, or both during the ingest.

6. The system of claim 5, wherein the buffer is further configured to deliver the broadcast program, the video-on-demand program, or both with the inserted advertisement program to a group of the plurality of subscribers.

7. The system of claim 1, wherein the buffer is further configured to store a portion of the broadcast program separately from the full portion of the broadcast program.

8. The system of claim 7, wherein the buffer is further configured to transmit the portion of the broadcast program to the first single subscriber based on a request for a broadcast program.

9. The system of claim 8, wherein the request for a broadcast program comprises a channel change request in a multi-channel network.

10. The system of claim 1, wherein the multiplexer comprises a DSLAM, an OLT, an EQAM modulator, or any combination thereof.

11. The system of claim 1, wherein the unicast video stream is delivered through a subscriber line, which comprises a copper line, a fiber optic line, a cable television line, or any combination thereof.

12. The system of claim 1, wherein the buffer comprises non-volatile storage, volatile storage, or both.

13. The system of claim 1, wherein the unicast video stream comprises a real time program for transmission to the single subscriber.

14. The system of claim 1, wherein the unicast video stream comprises a non-real time program for transmission to the single subscriber.

15. A system for unicast delivery of multimedia content, the system comprising:
a means for ingesting a broadcast program and a video-on-demand program;
a means for storing at least a portion of the broadcast program and at least a portion of the video-on-demand program; and
a means for delivering the broadcast program, the video-on-demand program, or both as a unicast video stream to a first single subscriber through a multiplexer connected to a plurality of subscribers.

16. A method for unicast delivery of multimedia content, the method comprising:
ingesting a broadcast program and a video-on-demand program;
storing at least a portion of the broadcast program and at least a portion of the video-on-demand program; and
delivering the broadcast program, the video-on-demand program, or both as a unicast video stream to a first single subscriber through a multiplexer connected to a plurality of subscribers.

17. The method of claim 16 further comprising storing a plurality of advertisement programs.

18. The method of claim 17 further comprising:
determining a first advertisement selected from the plurality of advertisement programs based on information associated with the first single subscriber, which is one of the plurality of subscribers; and
inserting the first advertisement program into the unicast video stream for delivery to the first single subscriber.

19. The method of claim 18 further comprising:
determining a second advertisement selected from the plurality of advertisement programs based on information associated with a second single subscriber, which is different than the first single subscriber and one of the plurality of subscribers; and
inserting the second advertisement program into a second unicast video stream for delivery to the second single subscriber.

20. The method of claim 17 further comprises inserting an advertisement program from the plurality of advertisement programs into the broadcast program, the video-on-demand program, or both during the ingesting.

21. The method of claim 20 further comprises delivering the broadcast program, the video-on-demand program, or both with the inserted advertisement program to a group of the plurality of subscribers.

22. The method of claim 16 further comprises storing a portion of the broadcast program separately from the full portion of the broadcast program.

23. The method of claim 22 further comprises transmitting the portion of the broadcast program to the single subscriber based on a request for a broadcast program.

24. The method of claim 23, wherein the request for a broadcast program comprises a channel change request in a multi-channel network.

25. A computer program product, tangibly embodied in an information carrier, the computer program product including instructions being operable to cause a data processing apparatus to:
ingest a broadcast program and a video-on-demand program;
store at least a portion of the broadcast program and at least a portion of the video-on-demand program; and
deliver the broadcast program, the video-on-demand program, or both as a unicast video stream to a first single subscriber through a multiplexer connected to a plurality of subscribers.

26-50. (canceled)
